(19) United States
(12) Patent Application Publication
(10) Pub. No.: US 2025/0377914 A1
(43) Pub. Date: Dec. 11, 2025

(54) TECHNIQUES FOR FACILITATING REMOTE SCREEN SHARING AND CONTROL

(71) Applicant: Apple Inc., Cupertino, CA (US)

(72) Inventors: Ryan A. WILLIAMS, Morgan Hill, CA (US); Christopher M. GARRIDO, San Jose, CA (US); Craig M. FEDERIGHI, Los Altos Hills, CA (US); David S. EVANS, San Ramon, CA (US); Jae Woo CHANG, San Jose, CA (US); Justin R. ETZINE, San Jose, CA (US); Timothy L. BIENZ, Cupertino, CA (US); Todd R. FERNANDEZ, Mountain View, CA (US)

(21) Appl. No.: 19/226,339

(22) Filed: Jun. 3, 2025

Related U.S. Application Data
(60) Provisional application No. 63/657,926, filed on Jun. 9, 2024.

(51) Int. Cl. G06F 9/451; G06F 3/14

(52) U.S. Cl. CPC G06F 9/452; G06F 3/1454

(57) ABSTRACT

A method for facilitating remote screen sharing and control between computing devices is disclosed. The method may include establishing, by a first application executing on a first device, a remote control session with a second application executing on a second device. The first application may receive, from the second application, layout information that includes an inset graphical user interface that is smaller than a primary graphical user interface of the second application. The first device may establish a placeholder view using the layout information, and use the placeholder view to size and position a graphical user interface.

### CROSS-REFERENCE TO RELATED APPLICATIONS

The present application claims the benefit of U.S. Provisional Application No. 63/657,926, entitled “TECHNIQUES FOR FACILITATING REMOTE SCREEN SHARING AND CONTROL,” filed Jun. 9, 2024, the content of which is incorporated by reference herein in its entirety for all purposes.

### FIELD

The described embodiments relate generally to remote screen sharing and control between computing devices. More particularly, the described embodiments set forth techniques for facilitating a remote session between computing devices in a manner that enables users to intuitively understand the current state of the remote session.

### BACKGROUND

During a remote control session between computing devices, users often face challenges in discerning whose screen they are looking at, who has control, and so on. One primary difficulty stems from the visual confusion that arises when remote and local screens display similar content. For example, if both users are working through operating systems, applications, etc., that are similar in nature, then distinguishing between the remote screen and their own can become convoluted. This confusion is exacerbated when there are no clear visual cues or differences, such as distinct desktop backgrounds or window arrangements, thereby making it easy to lose track of whose screen is being viewed, whose device is being controlled, and so on.

Another factor that adds to the aforementioned confusion is the lack of tactile feedback and physical presence, which can obscure control dynamics. In particular, during a remote session, users do not have the benefit of seeing the other person's physical actions, such as moving a mouse, touching a screen, typing on a keyboard, etc. As a result, misunderstandings can occur about who currently has control of the session. For example, one user may attempt to type or click, assuming they have control, only to realize that the other user has overridden their actions. This situation is particularly common in collaborative troubleshooting, training, etc., sessions, where control frequently shifts between participants.

Accordingly, what is needed are techniques for facilitating remote control sessions between computing devices in an intuitive manner.

### SUMMARY

The described embodiments relate generally to remote screen sharing and control between computing devices. More particularly, the described embodiments set forth techniques for facilitating a remote session between computing devices in a manner that enables users to intuitively understand the current state of the remote session.

One embodiment sets forth a method for facilitating remote screen sharing and control between computing devices, implemented by a controlled device. According to some embodiments, the method can be implemented by a first computing device that implements a first remote control application, and includes the steps of establishing an remote control session with a second remote control application implemented on a second computing device, receiving, from the second remote control application, layout information associated with at least an inset graphical user interface associated with the second remote control application, wherein the inset graphical user interface is smaller than a primary graphical user interface of the second remote control application, establishing, based on the layout information, a placeholder view within an operating system graphical user interface of the first computing device, wherein the operating system graphical user interface includes an operating system root layer graphical user interface that is initially sized in accordance with the operating system graphical user interface, and sizing and positioning the operating system root layer graphical user interface within the operating system graphical user interface in accordance with the placeholder view to establish an adjusted operating system root layer graphical user interface.

Another embodiment sets forth a method for facilitating remote screen sharing and control between computing devices, implemented by a controlling device. According to some embodiments, the method can be implemented by a first computing device that implements a first remote control application, and includes the steps of establishing an remote control session with a second remote control application implemented on a second computing device, establish, within the first remote control application, an inset graphical user interface that is smaller than a primary graphical user interface of the first remote control application, providing, to the second remote control application, layout information associated with at least the inset graphical user interface, receiving, from the second remote control application, an affine transformation matrix, and an operating system graphical user interface associated with the second computing device, wherein the operating system graphical user interface includes an adjusted operating system root layer graphical user interface, and the operating system graphical user interface includes information not included in the adjusted operating system root layer graphical user interface, applying, to the operating system graphical user interface, an inverse of the affine transformation matrix, to thereby increase the size and position of the adjusted operating system root layer graphical user interface to conform to the inset graphical user interface, and cropping the information that is included in the operating system graphical user interface but that is not included in the adjusted operating system root layer graphical user interface.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIGS. 2A-2B illustrate sequence diagrams of techniques for facilitating remote screen sharing and control between computing devices, according to some embodiments.

FIGS. 3A-3G illustrate conceptual diagrams of techniques for facilitating remote screen sharing and control between computing devices, according to some embodiments.

FIG. 4A illustrates a method implemented by a controlled computing device for facilitating remote screen sharing and control between computing devices, according to some embodiments.

FIG. 4B illustrates a method implemented by a controlling computing device for facilitating remote screen sharing and control between computing devices, according to some embodiments.

FIG. 5 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments relate generally to remote screen sharing and control between computing devices. More particularly, the described embodiments set forth techniques for facilitating a remote session between computing devices in a manner that enables users to intuitively understand the current state of the remote session.

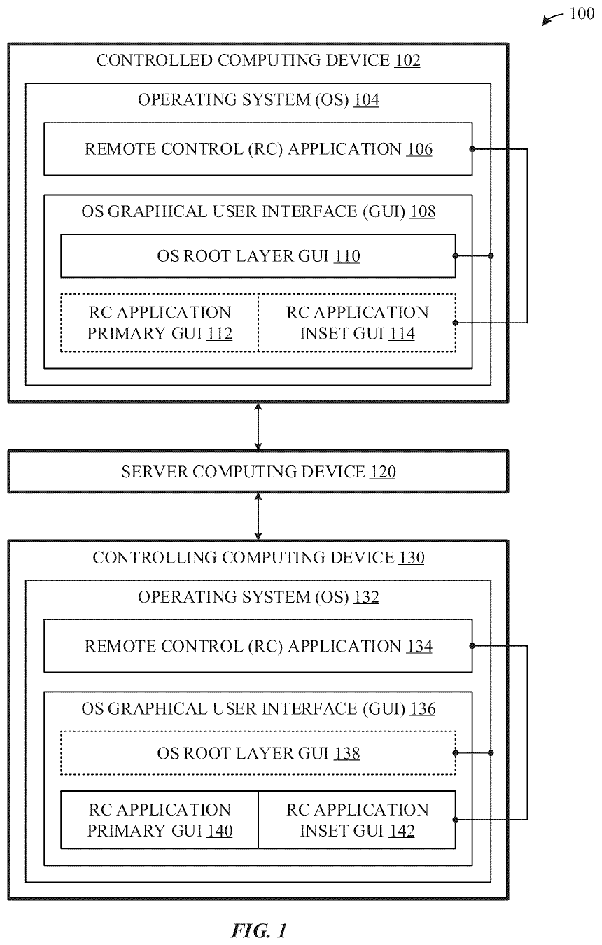

FIG. 1 illustrates a block diagram of different components of a system 100 that can be configured to implement the various techniques described herein, according to some embodiments. As shown in FIG. 1, the system 100 can include a controlled computing device 102, a controlling computing device 130, and a server computing device 120. It is noted that, in the interest of simplifying this disclosure, the aforementioned entities are typically discussed in singular capacities. In that regard, it should be appreciated that the system 100 can include any number of the aforementioned entities, consistent with the scope of this disclosure.

According to some embodiments, the controlled computing device 102/controlling computing device 130 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IOT) computing device, and so on. According to some embodiments, the server computing device 120 can represent any form of computing device, such as a blade server, a rack server, a tower server, and so on. It is noted that the foregoing examples are not meant to be limiting, and that the controlled computing device 102, controlling computing device 130, and server computing device 120 can represent any type, form, etc., of computing device, consistent with the scope of this disclosure.

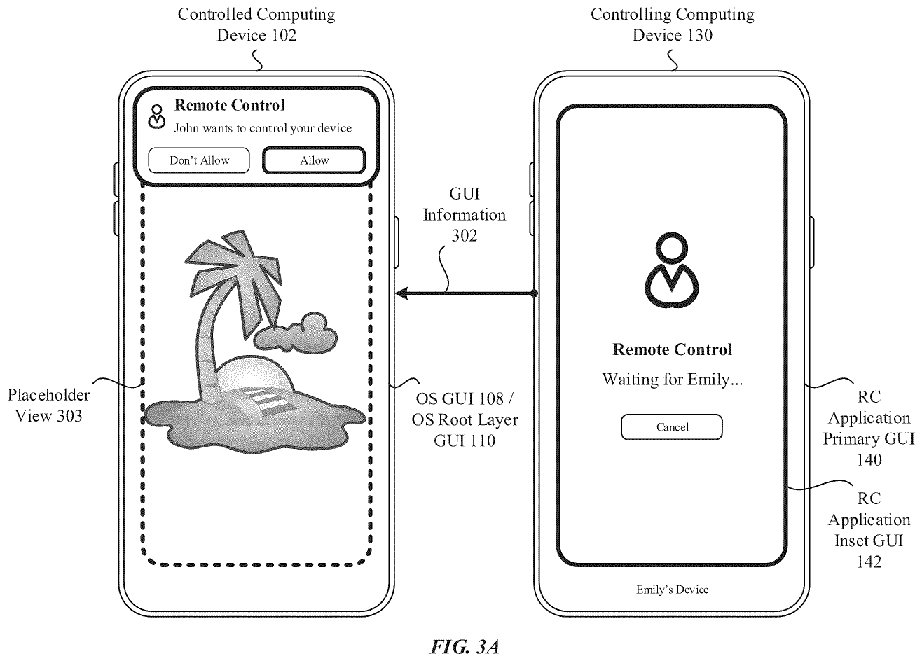

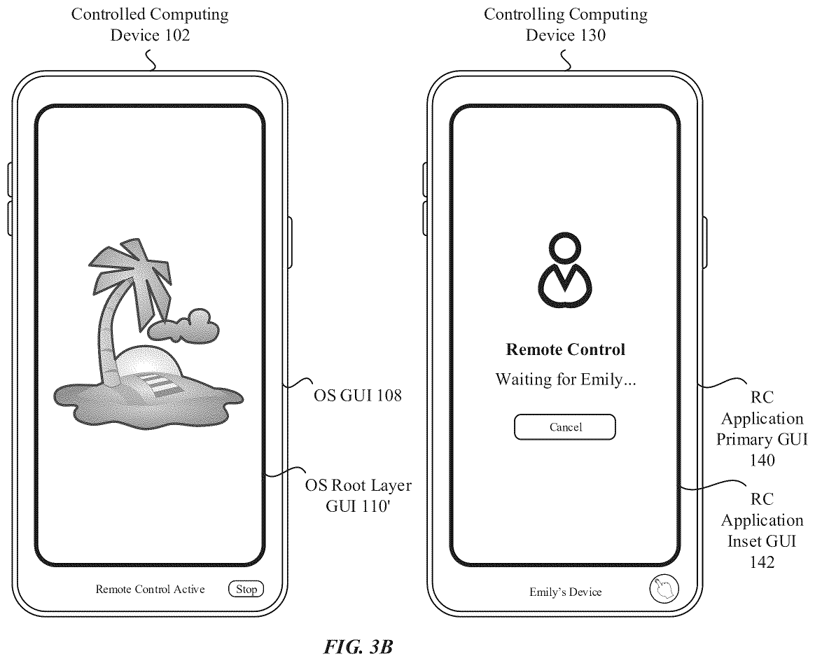

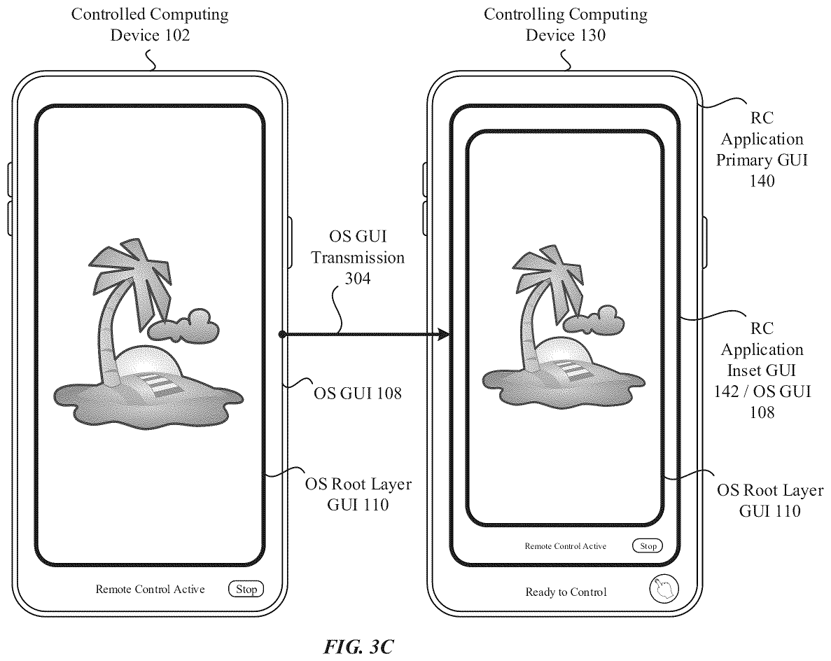

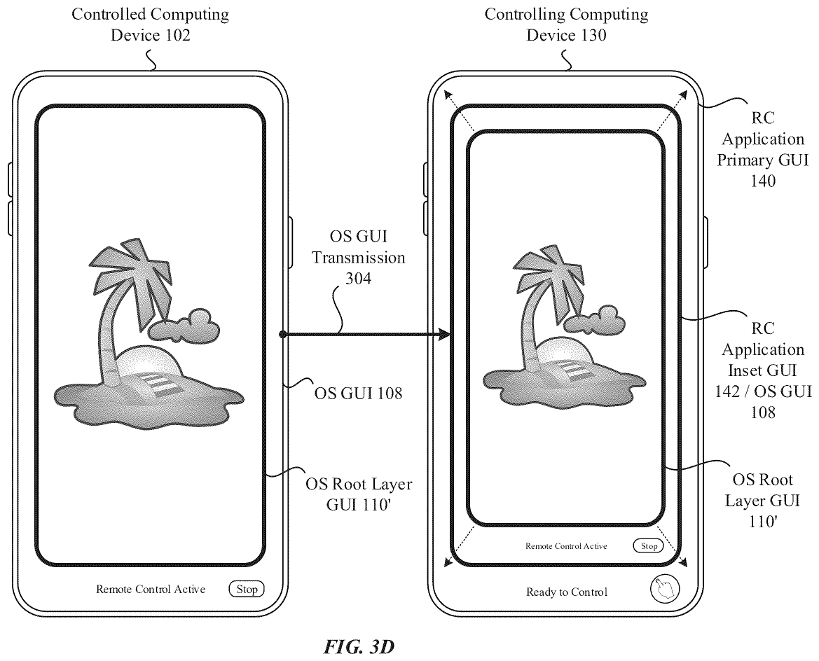

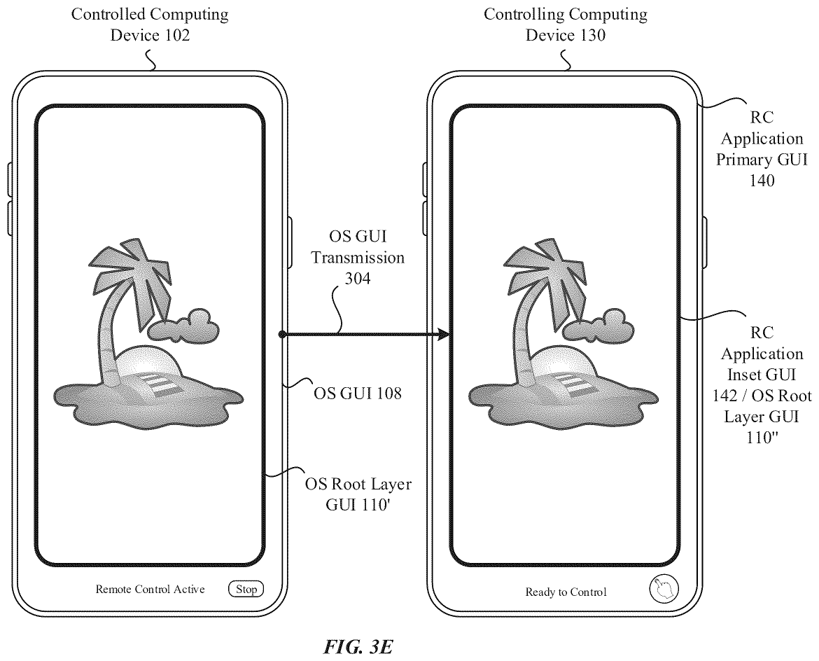

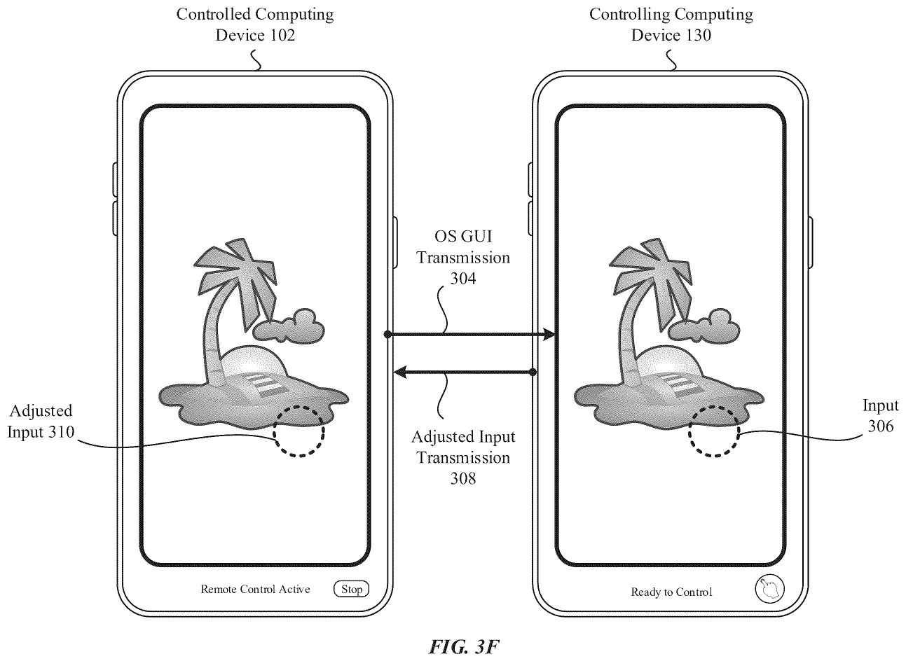

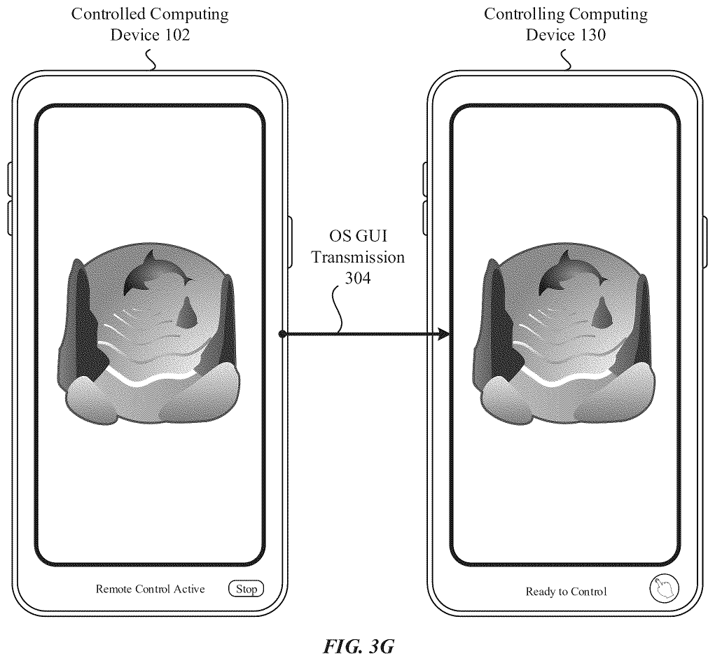

As shown in FIG. 1, the controlled computing device 102 can implement an operating system 104 that is configured to execute different applications (not illustrated in FIG. 1), such as first-party/native software applications, third-party applications, and so on. The controlled computing device 102 can also implement a remote control application 106 that enables the controlled computing device 102 to conduct remote screen sharing, control, etc., activities—referred to herein as “remote sessions”—with other computing devices on which counterpart remote control applications are installed, such as the controlling computing device 130. As shown in FIG. 1, the operating system 104 can be associated with, output, etc., an OS graphical user interface 108 that, for the purposes of this disclosure, represents a graphical user interface of the operating system 104 that spans a physical display screen with which the controlled computing device 102 is communicatively coupled (e.g., the example OS graphical user interface 108 illustrated in FIG. 3A).

As shown in FIG. 1, the OS graphical user interface 108 can be associated with, implement, include, encompass, etc., an OS root layer GUI 110. According to some embodiments, the OS root layer GUI 110 effectively spans the same area, outputs the same content, etc., as the OS graphical user interface 108, when the controlled computing device 102 is not conducting a remote session. However, when the controlled computing device 102 is conducting a remote session, the OS root layer GUI 110 can be decreased in size relative to the OS graphical user interface 108, where the OS root layer GUI 110 outputs a reduced-size version of the content that is normally output by way of the OS graphical user interface 108. In this regard, the OS graphical user interface 108 effectively forms a border area around the OS root layer GUI 110, and can be used to display content that is distinct from the content displayed by way of the OS root layer GUI 110 (e.g., a tool bar, a clock, connectivity information, etc.). FIG. 3A represents how the OS graphical user interface 108 and OS root layer GUI 110 can be arranged, function, etc., when the controlled computing device 102 is not conducting a remote session. Conversely, FIG. 3B illustrates how the OS graphical user interface 108 and OS root layer GUI 110 can be arranged, function, etc., when the controlled computing device 102 is conducting a remote session. It should be appreciated that other approaches can be utilized to manage the OS graphical user interface 108 and the OS root layer GUI 110. For example, the OS root layer GUI 110 can remain in an inactive state, be invisible, etc., when the controlled computing device 102 is not conducting a remote session, and can enter into an active state, be visible, etc., when the controlled computing device 102 is conducting a remote session.

As shown in FIG. 1, the OS graphical user interface 108 can also be associated with, implement, include, encompass, etc., user interfaces that correspond to the remote control application 106, including (i) a remote control application primary GUI 112, and (ii) a remote control application inset GUI 114. As described in greater detail herein, these GUIs can enable various functionalities to be implemented, e.g., establishing/terminating remote sessions, viewing shared screens, transmitting controls, and so on.

As shown in FIG. 1, the controlling computing device 130 can implement an operating system 132 in a manner similar to how the controlled computing device 102 implements the operating system 104. The operating system 132 can also implement a remote control application 134 that is similar to, compatible with, etc., the remote control application 106. For example, the remote control application 106 and the remote control application 134 can utilize the same communication protocols, provide access to the same communication services, etc., to effectively enable remote sessions to be conducted between the controlled computing device 102 and the controlling computing device 130. As shown in FIG. 1, an OS graphical user interface 136 of the operating system 132 can implement an OS root layer GUI 138 that can enable functionalities similar to those provided by the OS root layer GUI 110 described herein, particularly when the controlling computing device 130 functions as a controlled device in a remote session (rather than a controlling device, as primarily described herein).

Additionally, and as shown in FIG. 1, the OS graphical user interface 136 can also be associated with user interfaces that correspond to the remote control application 134, including (i) a remote control application primary GUI 140, and (ii) a remote control application inset GUI 142. According to some embodiments, the remote control application primary GUI 140 can enable various features provided by the remote control application 134 to be accessed, such as the ability to establish remote sessions, the ability to perform different tasks during the remote sessions, the ability to close remote sessions, and so on. An example of the remote control application primary GUI 140 is illustrated in FIG. 3A. According to some embodiments, the remote control application inset GUI 142 can function as an area in which a shared screen—e.g., that of controlled computing device 102 during a remote session with controlled computing device 102—can be displayed. An example of the remote control application inset GUI 142 is illustrated in FIG. 3A as well.

According to some embodiments, the server computing device 120 (and/or other computing devices) can facilitate communications between the controlled computing device 102 and the controlling computing device 130 to enable remote sessions to be established, maintained, and concluded. It should be appreciated that the server computing device 120 is optional, and that the controlled computing device 102/controlling computing device 130 can be configured to communicate directly with one another (e.g., via the Internet using secure communications protocols) to implement the techniques described herein, consistent with the scope of this disclosure.

It is noted that the logical breakdown of the entities illustrated in FIG. 1—as well as the logical flow of the manner(s) in which such entities communicate—should not be construed as limiting. On the contrary, any of the entities illustrated in FIG. 1 can be separated into additional entities within the system 100, combined together within the system 100, or removed from the system 100, consistent with the scope of this disclosure. It should additionally be understood that the computing devices can include additional entities that enable the implementation of the various techniques described herein, consistent with the scope of this disclosure. It should further be understood that the various entities described herein can be implemented using software-based or hardware-based approaches, consistent with the scope of this disclosure.

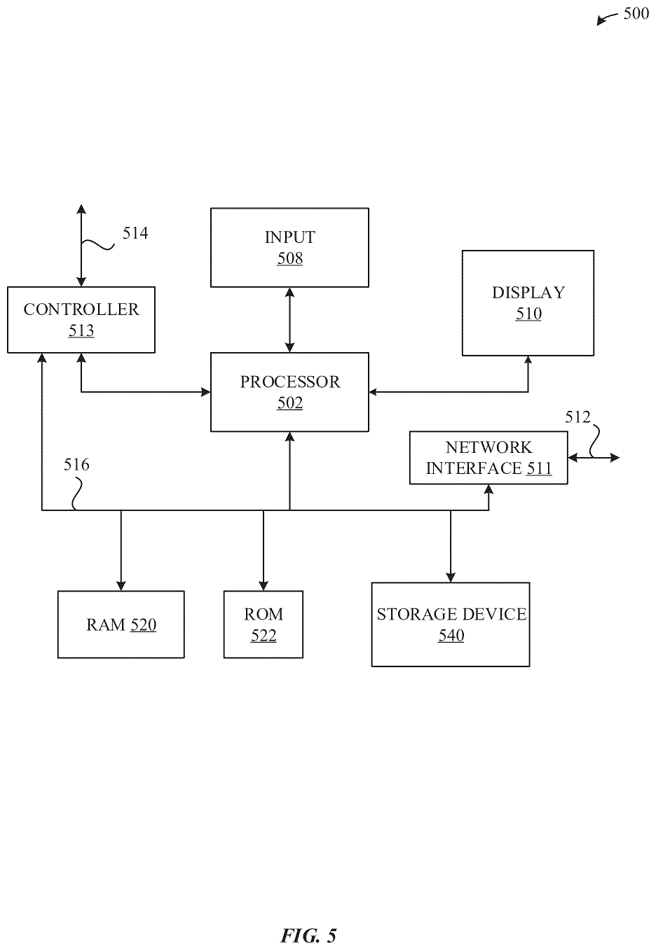

Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another. A more detailed explanation of these hardware components is provided below in conjunction with FIG. 5.

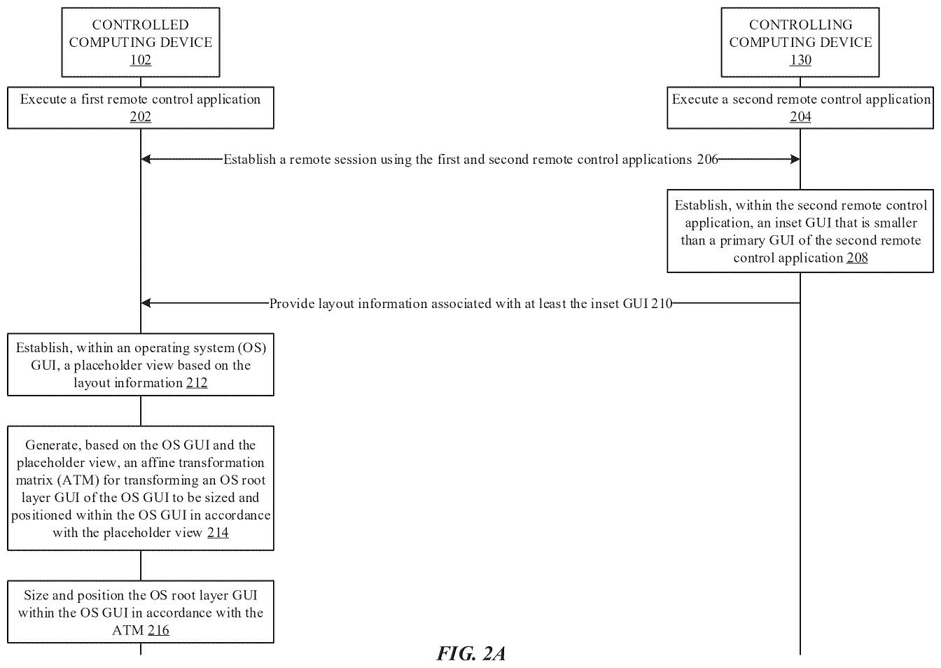

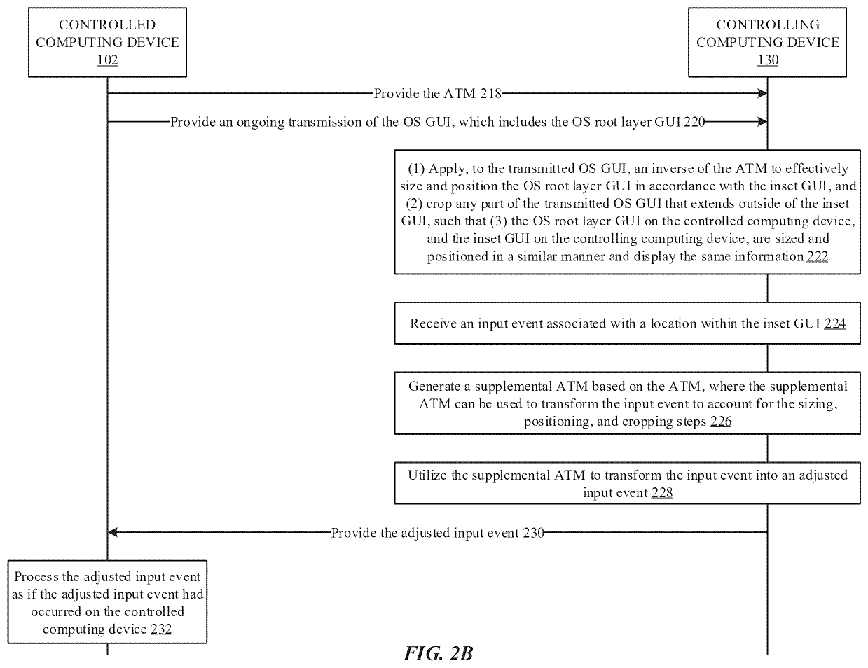

Accordingly, FIG. 1 provides an overview of the manner in which different computing devices can be configured to implement the various techniques described herein, according to some embodiments. A more detailed breakdown of the manner in which these techniques can be implemented is provided below in conjunction with FIGS. 2A-2B, 3A-3G, and 4A-4B.

FIGS. 2A-2B illustrate sequence diagrams of techniques for facilitating remote screen sharing and control between computing devices, according to some embodiments. As shown in FIG. 2A, steps 202 and 204 involve the controlled computing device 102 and the controlling computing device 130 executing a first remote control application (i.e., the remote control application 106) and a second remote control application (i.e., the remote control application 134), respectively, so that requests to form remote sessions can be received, initiated, etc., between the controlled computing device 102 and the controlling computing device 130 (and/or other computing devices that implement compatible remote control applications).

At step 206, the controlled computing device 102/controlling computing device 130 establish a remote session (using the remote control application 106/remote control application 134). In particular, the remote session can involve the controlling computing device 130 transmitting, to the controlled computing device 102, a request for the controlled computing device 102 to permit the controlling computing device 130 to control the controlled computing device 102. FIG. 3A illustrates an example scenario where the controlling computing device 130 has formed a communications link with the controlled computing device 102 (e.g., a voice call, a video call, etc.), and subsequently transmits a request to control the controlled computing device 102, (that, if granted, permits the controlling computing device 130 to view a screen of the controlled computing device 102 and to control the controlled computing device 102).

At step 208, the remote control application 134 establishes a remote control application inset GUI 142 that is smaller than a remote control application primary GUI 140 of the remote control application 134. The example scenario illustrated in FIG. 3A captures this notion, where the remote control application inset GUI 142 is smaller than the remote control application primary GUI 140, and is waiting to receive screen information from the controlled computing device 102 (e.g., after permission is granted on the controlled computing device 102 by way of the user interface (i.e., “Allow”) illustrated in FIG. 3A).

At step 210, the remote control application 134 provides layout information associated with at least the remote control application inset GUI 142. The layout information can include, for example, a position of the remote control application inset GUI 142 relative to the remote control application primary GUI 140, a position of the remote control application primary GUI 140 relative to a OS graphical user interface 136 (of the operating system 132 on the controlling computing device 130), and/or the like. The layout information can also include, for example, a size (e.g., length by width, in pixels) of the remote control application inset GUI 142, the remote control application primary GUI 140, the OS graphical user interface 136, and/or the like. It is noted that the foregoing examples are not meant to be limiting, and that the layout information can include any amount, type, form, etc., of information, at any level of granularity, consistent with the scope of this disclosure. The layout information, and transfer thereof, is illustrated in FIG. 3A as GUI information 302.

At step 212, the controlled computing device 102 establishes (e.g., in response to one or more commands issued by the remote control application 106 in response to receiving the layout information), within the OS graphical user interface 108, a placeholder view based on the layout information. An example of the placeholder view is illustrated in FIG. 3A as the placeholder view 303. As shown in FIG. 3A, the placeholder view on the controlled computing device 102 can be sized, positioned, etc., such that it mirrors (or substantially matches) the size, position, etc., of the remote control application inset GUI 142 on the controlling computing device 130.

At step 214, the controlled computing device 102 generates, based on the OS graphical user interface 108 and the placeholder view, an affine transformation matrix (ATM) for transforming the OS root layer GUI 110 (of the OS graphical user interface 108) to be sized and positioned within the OS graphical user interface 108 in accordance with the placeholder view. The ATM can be generated, for example, by comparing the position, dimensions, characteristics, etc., of the OS graphical user interface 108 to those of the placeholder view, to establish a model that enables content currently displayed by the controlled computing device 102 to be shrunken, repositioned, etc., so that it fits within the placeholder view. It is noted that the foregoing examples are not meant to be limiting, and that the controlled computing device 102 can implement any number, type, form, etc., of model(s), at any level of granularity, to effectively resize, reposition, etc., the OS root layer GUI 110 in accordance with the placeholder view, consistent with the scope of this disclosure.

At step 216, the controlled computing device 102 sizes and positions the OS root layer GUI 110 within the OS graphical user interface 108 in accordance with the ATM. This operation is illustrated in FIG. 3B, where the OS root layer GUI 110—which previously was sized in accordance with the OS graphical user interface 108 (i.e., when the controlled computing device 102 was not engaged in a remote session)—effectively shrinks to the size, position, etc., of the placeholder view, and transitions to the OS root layer GUI 110′. As shown in FIG. 3B, the OS graphical user interface 108 continues to display information outside of, complementary to, etc., the OS root layer GUI 110′, such as a toolbar that indicates “Remote Control Active” and provides an option (“Stop”) to terminate the remote session.

Turning now to FIG. 2B, at step 218, the remote control application 106 provides the ATM to the remote control application 134. According to some embodiments, the remote control application 106 can provide the ATM (to the remote control application 134) in response to receiving the ATM from the controlled computing device 102 (e.g., after steps 212-216 are carried out). In response, the remote control application 134 can store the ATM—which, as described herein, can be used to effectively position, size, etc., the shared screen of the controlled computing device 102 within the remote control application inset GUI 142.

At step 220, the remote control application 106 provides an ongoing transmission of the OS graphical user interface 108 (at least until the remote session is concluded, until sharing is reversed, etc.), which includes the OS root layer GUI 110′. This is represented in FIG. 3B as the OS GUI transmission 304. The transmission of the OS graphical user interface 108 (instead of, for example, only transmitting the OS root layer GUI 110′) can provide various optimizations. For example, little work is required from the controlled computing device 102, one or more graphics processing units (GPUs) on the controlled computing device 102, etc., given the OS graphical user interface 108 is already being generated and output on the controlled computing device 102 (in comparison to, for example, tasking the GPUs with extracting the OS root layer GUI 110 from the OS graphical user interface 108, separately outputting the OS root layer GUI 110′, etc.). As shown in FIG. 3C, the remote control application 134 can be configured to display the OS graphical user interface 108 and OS root layer GUI 110 within the remote control application inset GUI 142. However, if no further processing is performed on the OS graphical user interface 108, a telescoping effect occurs within the remote control application inset GUI 142, and extraneous information—e.g., the toolbar displayed on the controlled computing device 102—is inappropriately included within the shared screen.

To cure the aforementioned deficiencies, at step 222, the remote control application 134 applies, to the transmitted OS graphical user interface 108, an inverse of the ATM (received at step 218) to effectively size and position the OS root layer GUI 110 in accordance with the remote control application inset GUI 142. FIGS. 3D-3E capture this notion, where the OS graphical user interface 108 and OS root layer GUI 110 are expanded such that the OS root layer GUI 110′ is sized and positioned in accordance with the remote control application inset GUI 142. Consequently, because the OS graphical user interface 108 surrounds the OS root layer GUI 110′, the OS graphical user interface 108 increases in size as well, and continues to surround the OS root layer GUI 110′. In this regard, undesirable information—e.g., the toolbar displayed on the controlled computing device 102—can still be displayed on the controlling computing device 130.

To cure this deficiency, step 222 can also include the remote control application 134 cropping any part of the transmitted OS graphical user interface 108 that extends outside of the remote control application inset GUI 142. In this regard, at the conclusion of step 222, the OS root layer GUI 110′ on the controlled computing device 102, and the remote control application inset GUI 142 on the controlling computing device 130, are sized and positioned in a similar manner and display the same information, and no extraneous/undesirable information is displayed. The remote control application 134 can continue receiving the OS GUI transmission 304 and making the appropriate modifications so that the information is properly displayed on the controlling computing device 130. Accordingly, at the conclusion of step 222, the controlling computing device 130 is able to view the screen of the controlled computing device 102, and the controlling computing device 130 can be permitted to locally-receive, interpret, process, etc., input events and transmit the inputs to the controlled computing device 102.

At step 224, the remote control application 134 receives an input event associated with a location within the remote control application inset GUI 142, where the input event is to be forwarded to the controlled computing device 102 to be processed as a simulated input. For example, as shown in FIG. 3F, the controlling computing device 130 can receive an input 306. However, in view of the various transformations that take place between the GUIs—e.g., the shrinking, expanding, cropping, etc.—a transformation is required to effectively convert the coordinates of the input event received through the remote control application 134 to the appropriate coordinates that should apply to the controlled computing device 102.

Accordingly, at step 226, the remote control application 134 generates a supplemental ATM based on the ATM, where the supplemental ATM can be used to transform the input event to account for the sizing, positioning, and cropping steps described herein. Normalization can also be applied so that the transformed coordinates are valid (e.g., rounding to whole numbers). For example, if the location has the coordinates X and Y, then the transformed coordinates X′ and Y′ can be calculated based on ax+cy+tx, and bx+dy+ty, respectively, where a, b, c, d, tx, and ty are the components of the supplemental ATM. It is noted that the foregoing examples are not meant to be limiting, and that the input event can be effectively be transformed, converted, etc., using any feasible approach to be compatible with the controlled computing device 102 and processed, simulated, etc., by the controlled computing device 102 as if the input event had occurred at the same/relevant location on the controlled computing device 102 as it occurred on the controlling computing device 130.

At step 228, the remote control application 134 utilizes the supplemental ATM to transform the input event into an adjusted input event (to achieve the results discussed above in conjunction with step 226). At step 230, the remote control application 134 provides the adjusted input event to the remote control application 106 (illustrated in FIG. 3F as adjusted input transmission 308). At step 232, the remote control application 106 processes the adjusted input event as if the adjusted input event had occurred on the controlled computing device 102 the same way that it occurred on the controlling computing device 130 (illustrated in FIG. 3F as adjusted input 310). As shown in FIG. 3G, the input event causes the controlled computing device 102 to update the image being displayed. In turn, and through the techniques described herein, the OS GUI transmission 304 enables the controlling computing device 130 to reflect the changes.

The remote session can continue between the controlled computing device 102 and the controlling computing device 130, where the screen of the controlled computing device 102 is shared with the controlling computing device 130 (in accordance with the techniques described herein), and where input events are received by the controlling computing device 130 and transmitted to the controlled computing device 102 for simulation (in accordance with the techniques described herein).

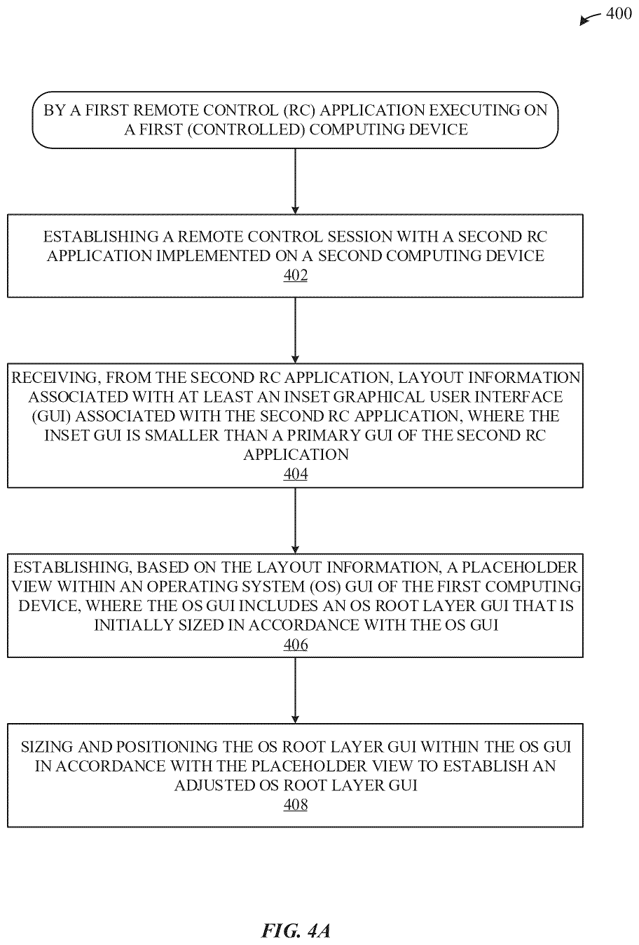

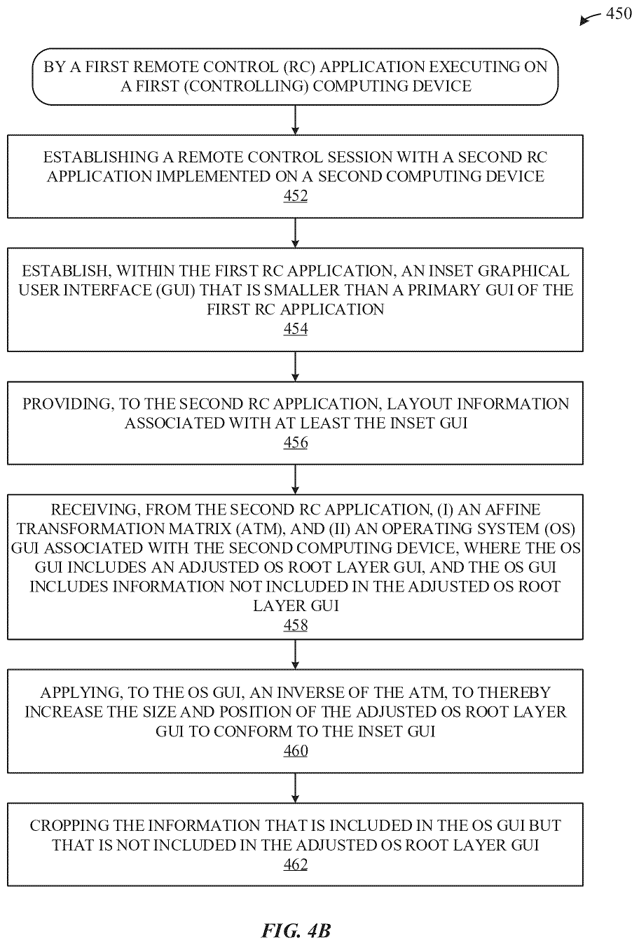

FIG. 4A illustrates a method 400 implemented by the controlled computing device 102 for facilitating remote screen sharing and control between computing devices, according to some embodiments. As shown in FIG. 4A, the method 400 begins at step 402, where the controlled computing device 102, executing a first remote control (RC) application, establishes a remote control session with a second RC application implemented on a second computing device (e.g., the controlling computing device 130) (e.g., as described in conjunction with FIGS. 1, 2A-2B, and 3A-3G).

At step 404, the controlled computing device 102 receives, from the second RC application, layout information associated with at least an inset graphical user interface (GUI) associated with the second RC application, where the inset GUI is smaller than a primary GUI of the second RC application (e.g., as described in conjunction with FIGS. 1, 2A-2B, and 3A-3G).

At step 406, the controlled computing device 102 establishes, based on the layout information, a placeholder view within an operating system (OS) GUI of the first computing device, where the OS GUI includes an OS root layer GUI that is initially sized in accordance with the OS GUI (e.g., as described in conjunction with FIGS. 1, 2A-2B, and 3A-3G).

At step 408, the controlled computing device 102 sizes and positions the OS root layer GUI within the OS GUI in accordance with the placeholder view to establish an adjusted OS root layer GUI (e.g., as described in conjunction with FIGS. 1, 2A-2B, and 3A-3G).

FIG. 4B illustrates a method 450 implemented by the controlling computing device 130 for facilitating remote screen sharing and control between computing devices, according to some embodiments. As shown in FIG. 4B, the method 450 begins at step 452, where the controlling computing device 130, executing a first remote control (RC) application, establishes a remote control session with a second RC application implemented on a second computing device (e.g., the controlled computing device 102) (e.g., as described in conjunction with FIGS. 1, 2A-2B, and 3A-3G).

At step 454, the controlling computing device 130 establishes, within the first RC application, an inset graphical user interface (GUI) that is smaller than a primary GUI of the first RC application (e.g., as described in conjunction with FIGS. 1, 2A-2B, and 3A-3G).

At step 456, the controlling computing device 130 provides, to the second RC application, layout information associated with at least the inset GUI (e.g., as described in conjunction with FIGS. 1, 2A-2B, and 3A-3G).

At step 458, the controlling computing device 130 receives, from the second RC application, (i) an affine transformation matrix (ATM), and (ii) an operating system (OS) GUI associated with the second computing device, where the OS GUI includes an adjusted OS root layer GUI, and the OS GUI includes information not included in the adjusted OS root layer GUI (e.g., as described in conjunction with FIGS. 1, 2A-2B, and 3A-3G).

At step 460, the controlling computing device 130 applies, to the OS GUI, an inverse of the atm, to thereby increase the size and position of the adjusted OS root layer GUI to conform to the inset GUI.

At step 462, the controlling computing device 130 crops the information that is included in the OS GUI but that is not included in the adjusted OS root layer GUI (e.g., as described in conjunction with FIGS. 1, 2A-2B, and 3A-3G).

FIG. 5 illustrates a detailed view of a computing device 500 that can be used to implement the various components described herein, according to some embodiments. In particular, the detailed view illustrates various components that can be included in the computing devices described above in conjunction with FIG. 1.

As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Furthermore, the computing device 500 can include a display 510 (screen display) that can be controlled by the processor 502 to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

The computing device 500 also includes a storage device 540, which can comprise a single disk or a plurality of disks (e.g., SSDs), and includes a storage management module that manages one or more partitions within the storage device 540. In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities, or processes to be executed in a non-volatile manner. The RAM 520 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for facilitating remote screen sharing and control between computing devices, the method comprising, by a first computing device that implements a first remote-control application:
establishing a remote-control session with a second remote-control application implemented on a second computing device;
receiving, from the second remote-control application, layout information associated with at least an inset graphical user interface associated with the second remote-control application, wherein the inset graphical user interface is smaller than a primary graphical user interface of the second remote-control application;
establishing, based on the layout information, a placeholder view within an operating system graphical user interface of the first computing device, wherein the operating system graphical user interface includes an operating system root layer graphical user interface that is initially sized in accordance with the operating system graphical user interface; and
sizing and positioning the operating system root layer graphical user interface within the operating system graphical user interface in accordance with the placeholder view to establish an adjusted operating system root layer graphical user interface.

2. The method of claim 1, wherein the placeholder view is sized and positioned within the operating system graphical user interface in accordance with how the inset graphical user interface is sized and positioned within the primary graphical user interface of the second remote-control application.

3. The method of claim 1, wherein sizing and positioning the operating system root layer graphical user interface comprises:
generating, based on the operating system graphical user interface and the placeholder view, an affine transformation matrix; and
transforming the operating system root layer graphical user interface based on the affine transformation matrix to produce the adjusted operating system root layer graphical user interface.

4. The method of claim 3, further comprising transmitting, to the second remote-control application, the affine transformation matrix and the operating system graphical user interface, wherein the operating system graphical user interface includes the adjusted operating system root layer graphical user interface, and wherein the operating system graphical user interface includes information not included in the adjusted operating system root layer graphical user interface.

5. The method of claim 4, wherein the second remote-control application, in conjunction with receiving the affine transformation matrix and the operating system graphical user interface:
applies, to the operating system graphical user interface, an inverse of the affine transformation matrix to thereby increase a size and position of the adjusted operating system root layer graphical user interface included in the operating system graphical user interface to conform to the inset graphical user interface; and
crops the information that is included in the operating system graphical user interface but is not included in the adjusted operating system root layer graphical user interface.

6. The method of claim 3, further comprising:
receiving a transformed input from the second computing device; and
processing the transformed input as if the transformed input were received locally on the first computing device.

7. A non-transitory computer-accessible storage medium having program instructions stored therein that, in response to execution by a computer system, causes the computer system to perform operations including:
implementing, by a first computing device, a first remote-control application;
establishing a remote-control session with a second remote-control application implemented on a second computing device;
receiving, from the second remote-control application, layout information associated with at least an inset graphical user interface associated with the second remote-control application, wherein the inset graphical user interface is smaller than a primary graphical user interface of the second remote-control application;
establishing, based on the layout information, a placeholder view within an operating system graphical user interface of the first computing device, wherein the operating system graphical user interface includes an operating system root layer graphical user interface that is initially sized in accordance with the operating system graphical user interface; and
sizing and positioning the operating system root layer graphical user interface within the operating system graphical user interface in accordance with the placeholder view to establish an adjusted operating system root layer graphical user interface.

8. The non-transitory computer-accessible storage medium of claim 7, wherein the placeholder view is sized and positioned within the operating system graphical user interface in accordance with how the inset graphical user interface is sized and positioned within the primary graphical user interface of the second remote-control application.

9. The non-transitory computer-accessible storage medium of claim 7, wherein sizing and positioning the operating system root layer graphical user interface comprises:
generating, based on the operating system graphical user interface and the placeholder view, an affine transformation matrix; and
transforming the operating system root layer graphical user interface based on the affine transformation matrix to produce the adjusted operating system root layer graphical user interface.

10. The non-transitory computer-accessible storage medium of claim 9, further comprising transmitting, to the second remote-control application, the affine transformation matrix and the operating system graphical user interface, wherein the operating system graphical user interface includes the adjusted operating system root layer graphical user interface, and wherein the operating system graphical user interface includes information not included in the adjusted operating system root layer graphical user interface.

11. The non-transitory computer-accessible storage medium of claim 10, wherein the second remote-control application, in conjunction with receiving the affine transformation matrix and the operating system graphical user interface:
applies, to the operating system graphical user interface, an inverse of the affine transformation matrix to thereby increase a size and position of the adjusted operating system root layer graphical user interface included in the operating system graphical user interface to conform to the inset graphical user interface; and
crops the information that is included in the operating system graphical user interface but is not included in the adjusted operating system root layer graphical user interface.

12. The non-transitory computer-accessible storage medium of claim 9, wherein the operations further include:
receiving a transformed input from the second computing device; and
processing the transformed input as if the transformed input were received locally on the first computing device.

13. The non-transitory computer-accessible storage medium of claim 12, wherein prior to transmitting the transformed input to the first computing device, the operations further include:
receiving, by the second computing device, an input;
generating, by the second computing device based on the affine transformation matrix, a supplemental affine transformation matrix; and
generating, by the second computing device, the transformed input based on the supplemental affine transformation matrix.

14. A method, comprising:
establishing, within a first remote-control application on a first computing device, an inset graphical user interface that is smaller than a primary graphical user interface of the first remote-control application;
establishing a remote-control session with a second remote-control application implemented on a second computing device;
providing, to the second remote-control application, layout information associated with at least the inset graphical user interface;
receiving, from the second remote-control application, an affine transformation matrix and an operating system graphical user interface associated with the second computing device, wherein the operating system graphical user interface includes an adjusted operating system root layer graphical user interface, and the operating system graphical user interface includes information not included in the adjusted operating system root layer graphical user interface;
applying, to the operating system graphical user interface, an inverse of the affine transformation matrix to thereby increase a size and position of the adjusted operating system root layer graphical user interface to conform to the inset graphical user interface; and
cropping the information that is included in the operating system graphical user interface but that is not included in the adjusted operating system root layer graphical user interface.

15. The method of claim 14, wherein the layout information causes the second computing device to:
establish, based on the layout information, a placeholder view within the operating system graphical user interface, wherein the operating system graphical user interface includes an operating system root layer graphical user interface that is initially sized in accordance with the operating system graphical user interface; and
size and position the operating system root layer graphical user interface within the operating system graphical user interface in accordance with the placeholder view to establish the adjusted operating system root layer graphical user interface.

16. The method of claim 15, wherein the placeholder view is sized and positioned within the operating system graphical user interface in accordance with how the inset graphical user interface is sized and positioned within the primary graphical user interface of the first remote-control application.

17. The method of claim 14, further comprising:
receiving an input on the first computing device;
generating, based on the affine transformation matrix, a supplemental affine transformation matrix; and
generating a transformed input based on the supplemental affine transformation matrix.

18. The method of claim 17, further comprising transmitting the transformed input to the second computing device to cause the second computing device to process the transformed input as if the transformed input were received locally on the second computing device.

19. The method of claim 14, wherein the information includes user interface controls that are visible on the second computing device but that should not be visible on the first computing device.

20. The method of claim 14, wherein receiving the operating system graphical user interface from the second computing device comprises receiving visual information associated with the operating system graphical user interface.
